(19) United States
(12) Patent Application Publication
(10) Pub. No.: US 2026/0093052 A1
(43) Pub. Date: Apr. 2, 2026

(54) METHOD FOR SEISMIC FRAGILITY ANALYSIS OF SHIELD TUNNEL CONSIDERING SURFACE SURCHARGE EFFECTS

(71) Applicant: Tongji University, Shanghai (CN)

(72) Inventors: Zhongkai Huang, Shanghai (CN); Dongmei Zhang, Shanghai (CN); Xingmian Deng, Shanghai (CN)

(21) Appl. No.: 19/342,560

(22) Filed: Sep. 27, 2025

(30) Foreign Application Priority Data
Sep. 27, 2024 (CN) 202411358682.3

(51) Int. Cl. G01V 1/28; E21F 17/00; G01V 1/30; G06F 30/23; G06F 111/10

(52) U.S. Cl. CPC G01V 1/282; E21F 17/00; G01V 1/30; G06F 30/23; G06F 2111/10

(57) ABSTRACT

A method for seismic fragility analysis of a shield tunnel considering surface surcharge effects includes the steps of: determining mechanical property parameters of tunnel materials and physical-mechanical parameters of soil layers; investigating case studies of surface surcharge to define surface surcharge scenarios; selecting seismic waves and performing one-dimensional equivalent linear site response analysis on soil conditions; establishing a dynamic finite element numerical model of a soil-tunnel system considering surface surcharge; defining ground motion intensity measures (IM), tunnel damage measures (DM), and damage states (DS); and establishing probabilistic seismic demand models for the tunnel under various surface surcharge effects. Based on key parameters, seismic fragility curves for tunnel structures under surface surcharge effects are established. Through a nonlinear incremental dynamic analysis method, this method establishes the finite element numerical model of the soil-tunnel system, allowing for quantitative assessment of tunnel seismic fragility and seismic performance under various surface surcharge effects.

### CROSS-REFERENCE TO RELATED APPLICATION

This application claims priority of Chinese Patent Application No. 202411358682.3, filed on Sep. 27, 2024, the entire contents of which are incorporated herein by reference.

### TECHNICAL FIELD

The present disclosure relates to the field of seismic risk assessment for tunnel structures, and in particular to a method for seismic fragility analysis of a shield tunnel considering surface surcharge effects.

### BACKGROUND

As urban development accelerates and above-ground space becomes increasingly scarce, the number of underground structures in China has grown significantly, and the applications have diversified. These structures serve essential functions in transportation systems, municipal water and power networks, resource extraction, and defense engineering. Among these, tunnels dedicated to passage and transportation are one of the most critical components. Seismic disasters and excessive surface surcharge can cause devastating damage to these structures, which in turn may result in substantial economic losses for the city and even threaten the safety of citizens' lives.

Seismic fragility is defined as the conditional probability of a structure exceeding a predefined damage state (DS) given a ground motion intensity measure (IM). It can allow for a quantitative evaluation of seismic performance and provide essential guidance for the seismic design in urban construction. Regarding the seismic fragility analysis of tunnel structures, numerous scholars have established various research methods, which can be primarily categorized into: (1) fragility analysis based on expert judgment; (2) fragility analysis based on historical earthquake damage investigation; (3) fragility analysis based on numerical methods; and (4) fragility analysis based on experimental data. In the early days, when scientific technology and numerical analysis tools were underdeveloped, the main approaches to fragility analysis were based on expert judgment and historical earthquake damage records. However, these methods, despite enabling quick preliminary evaluations, were somewhat subjective and lacked universal applicability to diverse geographical settings. Consequently, the methods fail to meet the demands of contemporary fragility analysis. With advances in science and technology, scholars have begun to employ methods such as numerical analysis to conduct detailed fragility analysis. These methods, which leverage large datasets to achieve precise results, have been widely adopted and refined by researchers.

Tunnel damage induced by surface surcharge is a commonly encountered situation in urban development. Given that metro line development is inherently forward-looking and plays a leading role in guiding urban economic growth, it is often accompanied by extensive commercial development along its routes. This, in turn, leads to the potential for surface surcharge induced by construction activities above the subway tunnels. It is evident, therefore, that analyzing surface surcharge effects on tunnels is of great practical significance for urban development. At present, the primary research methods for investigating surface surcharge effects on tunnels include: field measurement, model testing, numerical analysis, and theoretical analysis. The field measurement method yields highly reliable results. However, it is associated with high costs and long durations. Conversely, while model testing may struggle to replicate complex scenarios, it requires less time and can simulate a wider range of scenarios, making it a commonly adopted approach by researchers.

In addition to the horizontal shear deformation transmitted by the surrounding soil layers during an earthquake, tunnel structures are also subjected to vertical loads such as surface surcharge, thereby increasing the overall seismic damage risk of the structure. It is evident that surface surcharge conditions significantly affect the seismic performance of tunnel structures. However, this factor has not received adequate attention in existing research. Consequently, the relationship between surface surcharge and seismic behavior remains unclear, necessitating further analysis of the variation in seismic fragility of tunnel structures under surface surcharge effects. Therefore, developing a method for seismic fragility analysis of tunnels under various surface surcharge effects can provide recommendations and guidance for seismic optimization design and reinforcement strategies of tunnel structures, possessing important theoretical significance and practical engineering value.

### SUMMARY

An objective of the present application is to provide a method for seismic tunnel fragility analysis of tunnels, specifically addressing the scenario of combined surface surcharge and seismic action that may occur during actual construction. Based on a nonlinear incremental dynamic analysis method, this method establishes a finite element numerical model of a soil-tunnel system considering surface surcharge effects, allowing for quantitative assessment of tunnel seismic fragility and seismic performance under various surface surcharge effects.

The present application employs the following technical solutions:
a seismic vulnerability analysis method for a shield tunnel considering surface surcharge effects includes the steps of:
S1, determining mechanical property parameters of tunnel materials and physical-mechanical parameters of soil layers;
S2, investigating case studies of tunnels affected by surface surcharge to define reasonable locations, magnitudes, and extents of surface surcharge;
S3, selecting appropriate seismic waves, and performing one-dimensional equivalent linear site response analysis on soil conditions obtained in step S1 to derive elastic modulus and Rayleigh damping parameters of soil;
S4, establishing a dynamic finite element numerical model of a soil-tunnel system considering surface surcharge based on the physical-mechanical parameters of the tunnel and soil layers, the seismic waves, and surface surcharge scenarios, determined in Steps S1-S3; and designing various scenarios combining surface surcharge levels and seismic intensities, and obtaining dynamic responses of the soil-tunnel system through extensive numerical calculations;
S5, choosing a maximum peak ground acceleration (PGA) of an input seismic wave as a ground motion IM; selecting a tunnel diameter deformation ratio as a damage measure (DM); and determining tunnel DSs and DM thresholds corresponding to reaching the DSs;
S6, establishing probabilistic seismic demand models for the tunnel under various surface surcharge effects based on the ground motion IM and DM selected in Step S5, as shown in Equation (3):

$$lnDM = alnIM + b \qquad ( 3 )$$

where a and b are determined through regression analysis, and after the probabilistic demand model is established, key parameters for plotting the fragility curves are calculated: a median IM value and a logarithmic standard deviation β_{D} for each DS; and
S7, establishing seismic fragility curves for tunnel structures under surface surcharge effects based on the key parameters, as shown in Equation (5):

$${P}_{f} ( {d}_{s} \geq {d}_{{s}_{i}} \vert S ) = Φ [ \frac{1}{{β}_{tot}} \cdot ln ( \frac{S}{{S}_{mi}} ) ] \qquad ( 5 )$$

where P_{f} is defined as a probability of exceeding a particular DS dₛ_{ᵢ} when subjected to a seismic wave with a given IM; φ represents a cumulative probability function of standard normal distribution; Sₘᵢ is a threshold value of the ground motion IM corresponding to each DS, obtained from Step S6; and βₜₒₜ is a total logarithmic standard deviation.

In step S1, the mechanical property parameters of the tunnel materials include tunnel burial depth, tunnel diameter, lining thickness, and material parameters of concrete and steel reinforcement; and the physical-mechanical parameters of the soil layers include layer thickness, density, cohesion, internal friction angle, Poisson's ratio, and shear wave velocity.

In step S2, factors considered in determining the locations of the surface surcharge include: whether a center of the surcharge deviates from a center of the tunnel, a magnitude of an offset distance, as well as a load type and an extent.

In step S3, the performing one-dimensional equivalent linear site response analysis on the soil includes: establishing a numerical model of the soil layers using software, inputting the selected seismic wave into the model to calculate shear modulus of the soil, and deriving elastic modulus E of the soil using Equation (1); and determining a characteristic period of the soil layers, and calculating the Rayleigh damping parameters for the soil layers;

$$G = \frac{E}{2 ( 1 + μ )} \qquad ( 1 )$$

where G is the shear modulus, and μ is the Poisson's ratio of the soil layers.

In step S5, the tunnel diameter deformation ratio is calculated as shown in Equation (2):

$$\frac{Δ D}{D} = \frac{\vert {D}_{1} - {D}_{2} \vert}{{D}_{1}} \qquad ( 2 )$$

where D and D₁ represent tunnel diameters before seismic motion, D₂ represents a tunnel diameter after being subjected to the surface surcharge and seismic action, and ΔD represents a change in diameter.

In step S6, the logarithmic standard deviation β_{D} is calculated as shown in Equation (4):

$${β}_{D} = \sqrt{\frac{{\sum }_{i = 1}^{n} {[ ln ( DM ) - ln ( b \cdot {IM}^{a} ) ]}^{2}}{n - 2}} \qquad ( 4 )$$

where n is the number of numerical model calculation results.

In step S7, the total logarithmic standard deviation βₜₒₜ is calculated as shown in Equation (6):

$${β}_{tot} = \sqrt{{β}_{ds}^{2} + {β}_{C}^{2} + {β}_{D}^{2}} \qquad ( 6 )$$

where β_{ds}, β_{C}, and β_{D} represent an uncertainty in defining the DS, an uncertainty associated with the tunnel's seismic response and capacity, and an uncertainty in the ground motion, respectively.

The present disclosure has the following beneficial effects.

Traditional seismic fragility analyses for tunnels have incorporated factors such as burial depth, diameter, material properties of the tunnel itself, and soil characteristics, but the influence of external factors such as surface surcharge on seismic performance has often been neglected. Therefore, to quantitatively analyze the impact of surface surcharge on the seismic performance of tunnels, it is crucial to adopt a seismic fragility analysis method for tunnels considering surface surcharge effects. This method fully considers the impact of variations in the location, magnitude, and extent of surface surcharge on the seismic performance of tunnels. A two-dimensional finite element model is established, and a large number of numerical simulations are conducted to generate seismic fragility curves under different surcharge scenarios, facilitating a quantitative assessment of seismic fragility, thereby offering important insights for the seismic risk evaluation of tunnels under surface surcharge.

### BRIEF DESCRIPTION OF THE DRAWINGS

FIG. 1 shows a flowchart of a method for seismic fragility analysis of a tunnel considering surface surcharge effects.

FIG. 2 shows a schematic diagram of a location, dimensions, and a load position of the tunnel according to an embodiment.

FIG. 3 shows a schematic diagram of a probabilistic seismic demand model under surface surcharge effects according to an embodiment.

FIG. 4 shows seismic fragility curves for the tunnel under surface surcharge effects according to an embodiment.

### DETAILED DESCRIPTION

The technical solutions in the embodiments of the present disclosure are described below clearly and completely with reference to the accompanying drawings. Obviously, the described embodiments are merely some, but not all, of the embodiments of the present disclosure. Based on the embodiments of the present disclosure, all other embodiments obtained by those of ordinary skill in the art without creative effort fall within the scope of protection of the present disclosure.

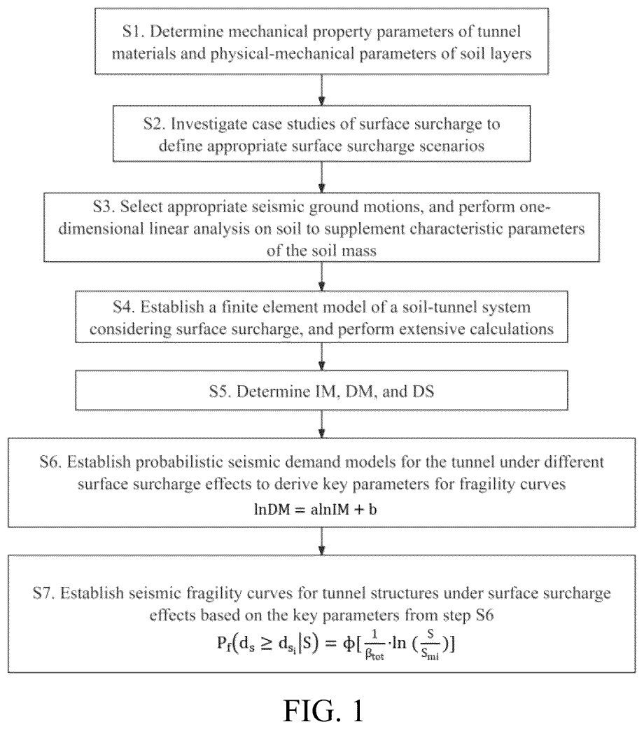

Referring to FIG. 1, a seismic vulnerability analysis method for a shield tunnel considering surface surcharge effects includes the steps that:

In S1, mechanical property parameters of tunnel materials and physical-mechanical parameters of soil layers are determined.

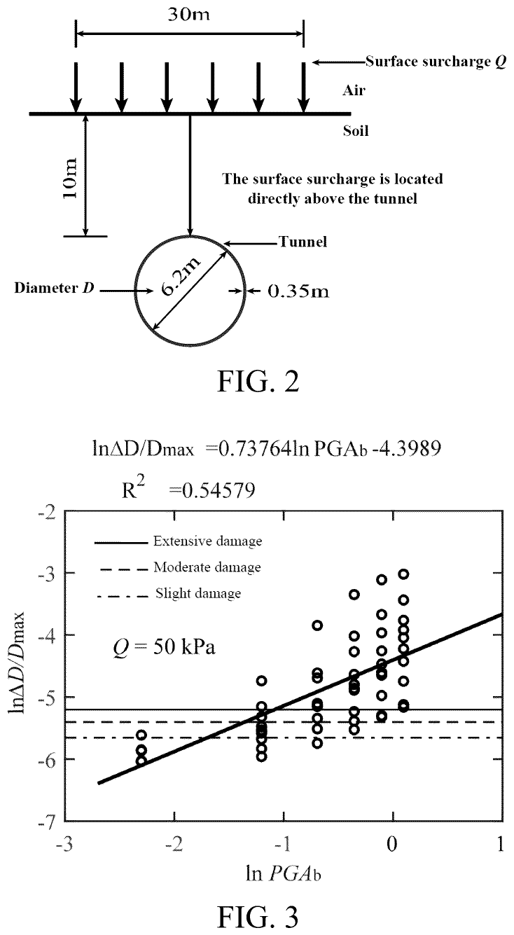

In this embodiment, the tunnel has a burial depth of 10 m, a cross-sectional diameter of 6.2 m, and a reinforced concrete lining thickness of 0.35 m. Its structural location is shown in FIG. 2, and material parameters are listed in Table 1.

TABLE 1
Tunnel material parameters

| Material parameter | Parameter value |
|---|---|
| Tunnel burial depth, z (m) | 10 |
| Tunnel outer diameter, d (m) | 6.2 |
| Lining thickness, h (m) | 0.35 |
| Concrete grade | C50 |
| Reinforcing steel grade | HRB400 |
| Area of flexural reinforcement, As (cm²/m) | 20.1 |
| Reinforcing steel diameter, W (mm) | 16 |

In S2, case studies of surface surcharge are investigated to define appropriate surface surcharge scenarios.

The case studies of tunnels in this area affected by surface surcharge are investigated to define realistic surcharge parameters such as location, distance to the tunnel, magnitude, extent, and whether it is a uniformly distributed load, providing a basis for follow-up numerical modeling. In this embodiment, the surface surcharge is applied directly above the tunnel with a lateral extent of 30 m. The surcharge scenarios considered are 0 kPa, 25 kPa, 50 kPa, 75 kPa, and 100 kPa.

In S3, appropriate seismic waves are selected, and one-dimensional linear analysis is performed on soil to supplement characteristic parameters of the soil.

A dozen or so appropriate seismic waves for numerical simulation are selected based on the seismic design code of the region under study, ensuring response spectra closely match the code's seismic influence coefficient spectrum curve. One-dimensional equivalent linear site response analysis is performed on the soil using one-dimensional linear analysis software to obtain equivalent shear modulus for each soil layer. These values are used in Equation (1) to determine elastic modulus E of soil layers.

$$G = \frac{E}{2 ( 1 + μ )} \qquad ( 1 )$$

where G is the shear modulus, and μ is the Poisson's ratio of the soil layers. Following the acquisition of the elastic modulus, a characteristic period of the soil layers needs to be determined. Rayleigh damping parameters for the soil layers are subsequently obtained through further calculation.

In S4, a finite element model of a soil-tunnel system considering surface surcharge is established, and extensive calculations are performed.

Based on the tunnel dimensions and material information from this embodiment, a dynamic finite element numerical model of the soil-tunnel system is developed. Concurrently, the surface surcharge is applied on a top surface of a soil surface of the model, and the seismic waves selected in Step S3 are input at a bottom of the model. The input seismic waves need amplitude modulation so that various intensity levels are adequately represented in the analysis. Following model establishment, extensive numerical calculations are conducted to obtain the dynamic response of the soil-tunnel system. The primary objective is to determine a tunnel diameter deformation ratio.

In S5, IM, DM, and DS are determined.

In this embodiment, PGA of the input seismic wave is selected as the IM. The tunnel diameter deformation ratio is chosen as the DM. The DS and corresponding DM extents are defined as shown in Table 2.

TABLE 2
Tunnel DM

| | | Median | |
|---|---|---|---|
| DS | DM extent | DM value | Tunnel performance |
| No damage | ΔD/D ≤ 3‰ | | Normal traffic flow is maintained. |
| Slight damage | 3‰ < ΔD/D ≤ 4‰ | 3.5‰ | The tunnel remains fully operational |
| | | | for all traffic. |
| Moderate damage | 4‰ < ΔD/D ≤ 5‰ | 4.5‰ | Normal traffic can resume after |
| | | | minor repairs. |
| Extensive damage | 5‰ < ΔD/D ≤ 6‰ | 5.5‰ | Traffic is permitted with speed |
| | | | restrictions only after major repairs. |
| Complete damage | ΔD/D > 6‰ | | |

The tunnel diameter deformation ratio is calculated as shown in Equation (2):

$$\frac{Δ D}{D} = \frac{\vert {D}_{1} - {D}_{2} \vert}{{D}_{1}} \qquad ( 2 )$$

where D and D₁ represent tunnel diameters before the seismic motion, D₂ represents a tunnel diameter after being subjected to the surface surcharge and seismic action, and ΔD represents a change in diameter.

In S6, probabilistic seismic demand models for the tunnel are established under different surface surcharge effects to derive key parameters for fragility curves.

The calculation results from the finite element model in Step S4 are collected and statistically processed. A best-fit line is plotted with lnIM as an independent variable and lnDM as a dependent variable (as shown in FIG. 3), thereby obtaining the probabilistic seismic demand model given by Equation (3):

$$ln DM = a ln IM + b \qquad ( 3 )$$

where a and b are linear regression parameters. After the probabilistic demand model is established, the key parameters for plotting the fragility curves are calculated: IM values corresponding to each DS (i.e., abscissa values of intersections between the fitted line and the DM thresholds, as shown in FIG. 3) and a logarithmic standard deviation β_{D}, which is computed using Equation (4):

$${β}_{D} = \sqrt{\frac{{\sum }_{i = 1}^{n} {[ ln ( DM ) - ln ( b \cdot {IM}^{a} ) ]}^{2}}{n - 2}} \qquad ( 4 )$$

where n is the number of numerical model calculation results.

In S7, based on the key parameters, seismic fragility curves for tunnel structures under surface surcharge effects are established.

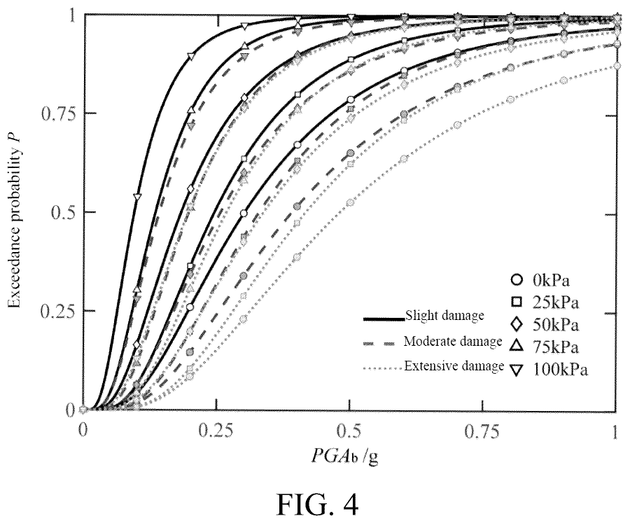

Based on the two key parameters obtained from the previous step, the seismic fragility curves for the tunnel under different surface surcharge conditions are established, as shown in FIG. 4. These fragility curves are expressed by Equation (5):

$${P}_{f} ( {d}_{s} \geq {d}_{{s}_{i}} \vert S ) = Φ [ \frac{1}{{β}_{tot}} \cdot ln ( \frac{S}{{S}_{mi}} ) ] \qquad ( 5 )$$

where β_{f} is defined as a probability of exceeding a particular DS dₛ_{ᵢ} when subjected to a seismic wave with a given IM; φ represents a cumulative probability function of standard normal distribution; Sₘᵢ is a threshold value of the ground motion IM corresponding to each DS, obtained from Step S6; and βₜₒₜ is a total logarithmic standard deviation, which quantifies the dispersion of the fragility curves, and is calculated using Equation (6):

$${β}_{tot} = \sqrt{{β}_{ds}^{2} + {β}_{C}^{2} + {β}_{D}^{2}} \qquad ( 6 )$$

where β_{ds}, β_{C}, and β_{D} represent an uncertainty in defining the DS, an uncertainty associated with the tunnel's seismic response and capacity, and an uncertainty in the ground motion, respectively. The values for β_{ds} and β_{C} are assigned as follows: β_{ds}=0.4 and β_{C}=0.3. The value of β_{D} is determined from the results of Step S6.

The seismic fragility of the tunnel under surface surcharge effects can be analyzed using FIG. 4. The results indicate that for the area of this embodiment, when a tunnel cover depth is small, the seismic performance of the tunnel deteriorates rapidly with increasing surface surcharge. Specifically, at a seismic IM of approximately 0.2 g, as the surface surcharge increases from 0 kPa to 100 kPa, the probability of slight damage increases by a factor of about 3.5, the probability of moderate damage increases by nearly 6 times, and the probability of extensive damage increases by almost 9 times. This embodiment demonstrates that the fragility curves developed through this method can quantitatively assess the seismic performance of the tunnel under various surface surcharge effects, including the degree of its degradation, thereby achieving a rational evaluation of seismic risk. This method is particularly suitable for seismic-prone regions where construction activities over existing tunnels introduce surface surcharges such as earth stockpiling. It provides crucial guidance and practical value for the seismic fragility analysis, seismic design, and construction of urban tunnels.

For those skilled in the art, obviously, the present disclosure is not limited to the details of the above exemplary embodiments, and the present disclosure may be realized in other specific forms, without departing from the spirit or essential feature of the present disclosure. Therefore, from any perspective, the embodiments are regarded as exemplary and non-restrictive.

1. A method for seismic fragility analysis of a shield tunnel considering surface surcharge effects, comprising the steps of:
S1, determining mechanical property parameters of tunnel materials and physical-mechanical parameters of soil layers;
S2, investigating case studies of tunnels affected by surface surcharge to define reasonable locations, magnitudes, and extents of surface surcharge;
S3, selecting appropriate seismic waves, and performing one-dimensional equivalent linear site response analysis on soil conditions obtained in step S1 to derive elastic modulus and Rayleigh damping parameters of soil;
S4, establishing a dynamic finite element numerical model of a soil-tunnel system considering surface surcharge based on the physical-mechanical parameters of the tunnel and soil layers, the seismic waves, and surface surcharge scenarios, determined in Steps S1-S3; and designing various scenarios combining surface surcharge levels and seismic intensities, and obtaining dynamic responses of the soil-tunnel system through extensive numerical calculations;
S5, choosing a maximum peak ground acceleration (PGA) of an input seismic wave as a ground motion intensity measure (TM); selecting a tunnel diameter deformation ratio as a damage measure (DM); and determining tunnel damage states (DSs) and DM thresholds corresponding to reaching the DSs;
S6, establishing probabilistic seismic demand models for the tunnel under various surface surcharge effects based on the ground motion IM and DM selected in Step S5, as shown in Equation (3):
$$ln DM = a ln IM + b \qquad ( 3 )$$
where a and b are determined through regression analysis, and after the probabilistic demand model is established, key parameters for plotting the fragility curves are calculated: a median IM value and a logarithmic standard deviation β_{D} for each DS.
S7, establishing seismic fragility curves for tunnel structures under surface surcharge effects based on the key parameters, as shown in Equation (5):
$${P}_{f} ( {d}_{s} \geq {d}_{{s}_{i}} \vert S ) = Φ [ \frac{1}{{β}_{tot}} \cdot ln ( \frac{S}{{S}_{mi}} ) ] \qquad ( 5 )$$
where β_{f} is defined as a probability of exceeding a particular DS dₛ_{ᵢ} when subjected to a seismic wave with a given IM; φ represents a cumulative probability function of standard normal distribution; Sₘᵢ is a threshold value of the ground motion IM corresponding to each DS, obtained from Step S6; and βₜₒₜ is a total logarithmic standard deviation.

2. The method for seismic fragility analysis of a shield tunnel considering surface surcharge effects according to claim 1, wherein in step S1, the mechanical property parameters of the tunnel materials comprise tunnel burial depth, tunnel diameter, lining thickness, and material parameters of concrete and steel reinforcement; and the physical-mechanical parameters of the soil layers comprise layer thickness, density, cohesion, internal friction angle, Poisson's ratio, and shear wave velocity.

3. The method for seismic fragility analysis of a shield tunnel considering surface surcharge effects according to claim 1, wherein in step S2, factors considered in determining the locations of the surface surcharge comprise: whether a center of the surcharge deviates from a center of the tunnel, a magnitude of an offset distance, as well as a load type and an extent.

4. The method for seismic fragility analysis of a shield tunnel considering surface surcharge effects according to claim 1, wherein in step S3, the performing one-dimensional equivalent linear site response analysis on the soil comprises: establishing a numerical model of the soil layers using software, inputting the selected seismic wave into the model to calculate shear modulus of the soil, and deriving elastic modulus E of the soil using Equation (1); and determining a characteristic period of the soil layers, and calculating the Rayleigh damping parameters for the soil layers;
$$G = \frac{E}{2 ( 1 + μ )} \qquad ( 1 )$$
where G is the shear modulus, and μ is the Poisson's ratio of the soil layers.

5. The method for seismic fragility analysis of a shield tunnel considering surface surcharge effects according to claim 1, wherein in step S5, the tunnel diameter deformation ratio is calculated as shown in Equation (2):
$$\frac{Δ D}{D} = \frac{\vert {D}_{1} - {D}_{2} \vert}{{D}_{1}} \qquad ( 2 )$$
where D and D₁ represent tunnel diameters before seismic motion, D₂ represents a tunnel diameter after being subjected to the surface surcharge and seismic action, and ΔD represents a change in diameter.

6. The method for seismic fragility analysis of a shield tunnel considering surface surcharge effects according to claim 1, wherein in step S6, the logarithmic standard deviation β_{D} is calculated as shown in Equation (4):
$${β}_{D} = \sqrt{\frac{{\sum }_{i = 1}^{n} {[ ln ( DM ) - ln ( b \cdot {IM}^{a} ) ]}^{2}}{n - 2}} \qquad ( 4 )$$
where n is the number of numerical model calculation results.

7. The method for seismic fragility analysis of a shield tunnel considering surface surcharge effects according to claim 1, wherein in step S7, the total logarithmic standard deviation βₜₒₜ is calculated as shown in Equation (6):
$${β}_{tot} = \sqrt{{β}_{ds}^{2} + {β}_{C}^{2} + {β}_{D}^{2}} \qquad ( 6 )$$
where β_{ds}, β_{C}, and β_{D} represent an uncertainty in defining the DS, an uncertainty associated with the tunnel's seismic response and capacity, and an uncertainty in the ground motion, respectively.
